(19) United States
(12) Patent Application Publication
(10) Pub. No.: US 2017/0041136 A1
(43) Pub. Date: Feb. 9, 2017

(54) IDENTIFICATION OF AN APPLICATION BASED ON PACKET SIZE

(71) Applicant: TREND MICRO INCORPORATED, Yoyogi (JP)

(72) Inventors: Brandon Niemczyk, Austin, TX (US); Josiah Dede Hagen, Austin, TX (US); Prasad V. Rao, Princeton, NJ (US)

(21) Appl. No.: 14/819,963

(22) Filed: Aug. 6, 2015

(51) Int. Cl. H04L 9/08

(52) U.S. Cl. CPC H04L 9/08

(57) ABSTRACT

Examples herein disclose packet size information collected over an encrypted tunnel. The examples identify an application communicated via the encrypted tunnel based on the packet size information.

### BACKGROUND

Data packets are formatted units of data which may be carried across a communication channel between networks. Tunneling is a protocol that allows for a secure movement of these data packets from one networking to another.

### BRIEF DESCRIPTION OF THE DRAWINGS

In the accompanying drawings, like numerals refer to like components or blocks. The following detailed description references the drawings, wherein:

FIG. 1 is a block diagram of an example networking device to identify an application communicated over an encrypted tunnel based on packet size information from a data packet;

FIG. 2A is a diagram of example packet sizes communicated via an encrypted tunnel over an interval of time;

FIG. 2B is a diagram of example classifiers to determine particular packet sizes of data packets for a controller to identify an application and tunneling protocol of the data packets;

FIG. 3 is a flowchart of an example method executable by a networking device to identify an application associated with data packets communicated via an encrypted tunnel;

FIG. 4 is a flowchart of an example method executable by a networking device to identify an application and tunneling protocol based on packet size information collected over an encrypted tunnel;

FIG. 5 is a block diagram of an example computing device with a processing resource to execute instructions in a machine-readable storage medium for determining an application based on packet size information collected over an interval time from an encrypted tunnel; and

FIG. 6 is a block diagram of an example computing device with a processing resource to execute instructions in a machine-readable storage medium for determining an application and tunneling protocol based on packet size information collected from an encrypted tunnel.

### DETAILED DESCRIPTION

Tunneling involves private network communications to be sent across a public network by repackaging data packets through an encapsulation process. The encapsulation process hides the communications of the data packets (i.e., data traffic) so they appear as though they are of a public nature. During the encapsulation process, data packets are encrypted as they are moved through the tunnel. At the final destination, de-capsulation and/or decryption of the data packets occur. This hides the applications and activities of the data packets during transit. The applications and/or activities of the data packets may violate various policies and/or cause competitive disadvantages. For example, a network administrator may survey the data packets to determine if the communications comply with various security policies.

To address these issues, examples disclosed herein provide a visibility of the various applications which may communicate over an encrypted tunnel. The examples collect packet size information from an encrypted tunnel. The packet size information is collected from data packets which are in transit over the encrypted tunnel. Based on the packet size information, the examples identify the application which communicated via the encrypted tunnel. The examples use the packet size information to determine what applications and/or activities a user may be utilizing over the encrypted tunnel. Determining what applications the user may be utilizing provides the visibility to identify the various applications which may be communicated over the encrypted tunnel. Additionally, the applications and/or activities of the data traffic in the encrypted tunnel may be identified without performing decryption of the packets. Identifying the applications and/or activities may further be used to enforce network and or security policies. For example, the type of applications may be prioritized so the higher prioritized applications may be transmitted over the lower prioritized applications.

In other examples discussed herein, a tunneling protocol is identified based on the packet size information. The packet size information is considered the various packet lengths of the data packets being communicated via the encrypted tunnel. A specific or particular packet length among the various packet lengths may correspond to a specific combination of the application and tunneling protocol. Identifying the specific or particular packet length which occurs more frequently among the data packets enables the examples to identify the application and the tunneling protocol. Identifying the tunneling protocol provides an additional level of visibility to see what tunneling protocols may be used more frequently.

In a further example, the packet size information is collected over an interval of time. The interval of time is a specified period of time in which to collect the packet size information from the data packets. The interval of time is an optimal period of time in which to further collect the packet size information. This provides an additional feature in which to identify the application being communicated over the encrypted tunnel.

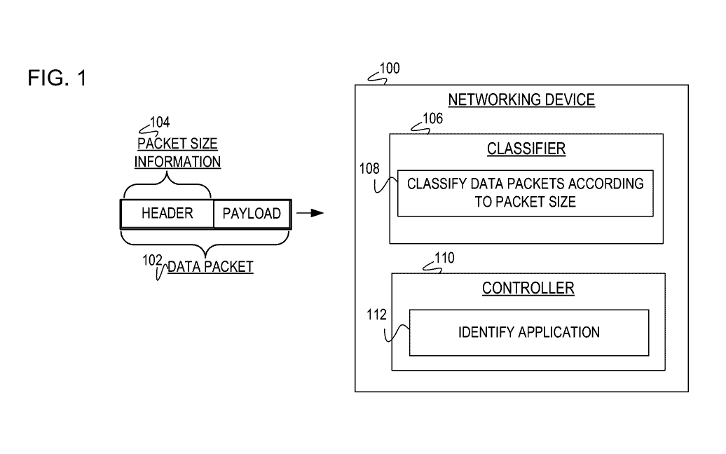

Referring now to the figures, FIG. 1 is a block diagram of a networking system including a networking device 100 to receive a data packet 102. FIG. 1 represents a networking system in which networking device 100 may exchange data in the form of data packet 102. The networking device 100 may establish data connections in the form of communication channels with other networking devices to route the data packet 102. Implementations of the networking system include, by way of example, a telecommunications network, Internet, Ethernet, wide area network (WAN), local area network (LAN), optic cable network, virtual network or other type of networking system to route data packets 102. Implementations of the networking device 100 include, by way of example, a router, switch, multi-port network device, multi-layer switch, media access control (MAC) switch, virtual switch or other type of networking component capable of routing data packet 102. Further, although FIG. 1 illustrates a single networking device 100 and data packet 102, implementations should not be limited as FIG. 1 represents the networking system which may include multiple networking device(s) 100 and data packet(s) 102.

The networking system includes the networking device 100, a classifier 106, and a controller 110. The networking device 100 receives the data packet 102 with packet size information 104. Based on the packet size information 104, the classifier 106 classifies the data packet 102 according to a particular packet size at module 108. The controller 110 identifies an application at module 112 corresponding to the particular packet size. The application is a program designed to permit a computing device to perform a group of coordinated functions, tasks, or activities. As such, the application may be communicated over an encrypted tunnel using the data packet(s) 102. The encrypted tunnel is a communication channel in which the data packet 102 is encrypted during transit. Accordingly, the data packet 102 may be encrypted using various tunneling protocols. The tunneling involves repackaging the data packet(s) 102 into an encrypted form, such that application of the data packet 102 is hidden. As the data packets are repackaged into an encrypted form, tunneling is the communication medium in which the encrypted data packets travel. This means the payload of the data packet 102 is hidden such that the networking device 100 may not be able to identify the application in use by the data packet 102. Accordingly, the networking device 100 uses the packet size information 104 to identify the application being communicated over the encrypted tunnel.

The data packet 102 is considered a networking packet which is a formatted unit of data carried by the networking system. The data packet 102 consists of at least two kinds of data including a header and user data (i.e., the payload). As such, the header includes the data packet size information 104. The payload is the part of the data packet 102 which carries the application data. As explained earlier, the data packet 102 is encrypted in such a manner that application data within the payload is hidden from the networking device 100. In this implementation, the data packet 102 transferred over the tunnel may be encrypted using various tunneling protocols. Such tunneling protocols include secure shell (SSH), point-to-point tunneling protocol (PPTP), layer two tunneling protocol (L2TP), secure socket tunneling protocol (SSTP), virtual private network (VPN), etc.

The packet size information 104 is collected by the networking device 100 to identify the application corresponding to the specific packet size. In one implementation, the networking device 100 collects the packet size information 104 for a specified period of time. The packet size information 104 is included within the header as part of the data packet 102. The packet size information 104 is the information which indicates the particular packet size of the data packet 102. The particular packet size represents a specific packet length of the data packet 102. As such, the specific packet length is a clearly defined value to represent an amount of length for the given data packet 102. The terms “particular packet size” and “specific packet length” each represents a physical dimension of space associated with the data packet 102 and thus may be used interchangeably throughout this document.

The classifier 106 classifies the data packet 102 over the encrypted tunnel according to the particular packet size. The classifier 106 corresponds to a specific application such that the classifier can identify those data packets 102 with the corresponding specific packet size from the encrypted tunnel. Upon the networking device 100 receiving data packet(s) 102, the classifier 106 organizes each of these data packets 102 according to the specific packet length of the given data packet 102. The specific packet length corresponds to the specific application for the various packet lengths. For example, each classifier may organize the data packets according to a different specific data packet length. Organizing according to the different specific packet length enables each data packet length to correspond to a different application. In this implementation, various classifier may be utilized to process the data packets 102, each classifier represents a different application. The classifier 106 is considered a machine-learning engine that processes the packet size information 104. The classifier 106 may be implemented through a variety of statistical models, such as a decision tree, likelihood function, etc. As such, the classifier 106 may include, by way of example, instructions (e.g., stored on a machine-readable medium) that, when executed (e.g., by the networking device 100), implements the functionality of the classifier 106. Alternatively, or in addition, the classifier 106 may include electronic circuitry that implements the functionality of the classifier 106.

At module 108, the classifier 108 organizes the data packet 102 in accordance with the packet size information 104. In one implementation, the classifier 108 tracks a number of data packets 102 which correspond to the specific packet size. The module 108 may include, by way of example, instructions (e.g., stored on a machine-readable medium) that, when executed (e.g., by the networking device 100), implements the functionality of module 108. Alternatively, or in addition, the module 108 may include electronic circuitry (i.e., hardware) that implements the functionality of module 108.

The controller 110 identifies the application at module 112 based on the packet size information 104 of the data packet 102. The controller 110 may include, by way of example, a microcontroller, integrated circuit, processing device, semiconductor, circuit, or other type of hardware component for identifying the application associated with the data packet 102 communicated via the encrypted tunnel.

At module 112, the controller 110 identifies the application communicated over the encrypted tunnel. The controller 110 may utilize information form the classifier 106, such as the number of data packets corresponding to the specific packet size to identify the application. Using the packet size information 104, the networking device 100 may determine the application being communicated over the encrypted tunnel without decrypting the data packets 102. The module 112 may include, by way of example, instructions (e.g., stored on a machine-readable medium) that, when executed (e.g., by the networking device 100), implement the functionality of module 112. Alternatively, or in addition, the module 112 may include electronic circuitry (i.e., hardware) that implements the functionality of module 112.

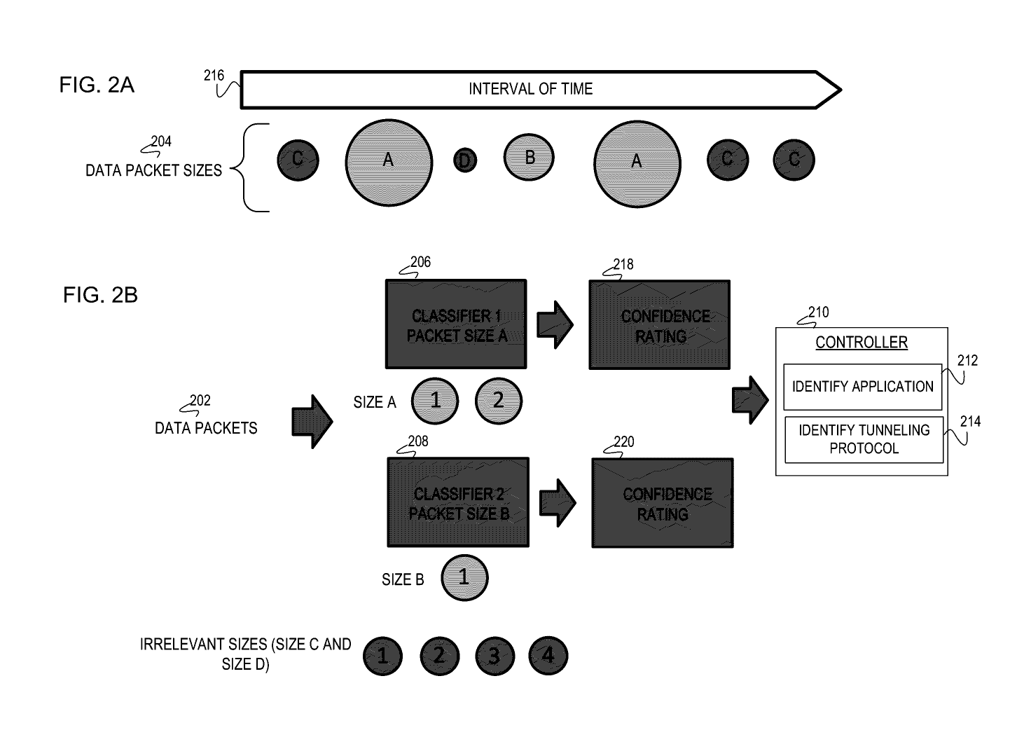

FIGS. 2A-2B illustrate various data packet sizes 204 collected over interval of time 216. The various data packet sizes 204 are identified at various classifiers 206 and 208. Each of the various classifiers 206 and 208 classify data packets 202 for a controller 210 to identify an application and tunneling protocol at modules 212-214.

FIG. 2A illustrates the various data packet sizes 204 (Sizes A-D) communicated via an encrypted tunnel. The various data packet sizes 204 are collected over the interval of time 216. The various data packet sizes 204 represent a range of sizes of length for a given data packet. Each data packet size 204 may represent a single data packet collected at a point in the interval of time 216. For example, there are seven different data packets with four different packet sizes (Sizes A-D). The interval of time 216 is a specified period of time in which a networking device may collect the data packets. The interval of time 216 indicates an optimal period of time in which to collect the data packet sizes to identify the application. In this implementation, the interval of time 216 may be dependent on the application which is being communicated. For example, one application may be communicated over the encrypted tunnel for ten seconds, while a different application may be communicated over the encrypted tunnel for two seconds.

FIG. 2B illustrates the example classifier 206 and 208 to filter the various data packet sizes 204 from FIG. 2A. The various data packet sizes 204 are filtered by classifiers 206 and 208 to identify those data packet sizes which correspond to the classifiers 206 and 208. Identifying the specific data packet sizes (Size A and Size B) corresponding to the classifiers 206 and 208, confidence ratings 218 and 220 may be determined. Upon determining the confidence ratings 218 and 220, a controller 210 identifies an application and tunneling protocol at modules 212-214. Each of the components 206, 208, and 210 are located as part of a networking device to receive data packets 202 from over an encrypted tunnel for detecting the application and tunneling protocol.

The various data packet sizes 204 are those packet lengths among the data packets 202 which are communicated via the encrypted tunnel. The various data packets 204 are filtered by the classifiers 206 and 208. Each classifier 206 and 208 corresponds to a different packet size (Size A and Size B) to filter the various data packet sizes for identifying those data packet sizes corresponding to the each classifier 206 and 208. For example, Classifier 1 206 filters the data packets 202 to identify those data packets which correspond to Size A. Classifier 2 208 filters the data packets 202 to identify those data packets which correspond to Size B. In one implementation, upon identifying those data packets which correspond to each of the classifiers 206 and 208, the irrelevant sizes (Size C and Size D) of data packets are discarded.

Each of the data packets sizes specific to the classifiers 206 and 208 represent a different application. Meaning Classifier 1 206 which corresponds Size A represents a different application than classifier 2 which corresponds to Size B. In this implementation, multiple classifiers 206 and 208 are utilized for identifying different packet sizes and applications. The classifiers 206 and 208 determine a number of data packets which correspond to the particular packet size. Identifying the number of data packets, the confidence rating 218 and 220 is determined for the controller 210 to identify the application and tunneling protocol. For example, Classifier 1 206 identifies two Size A packets, while Classifier 2 208 identifies one Size B packet. The number of data packets in the predetermined time interval 216 may be used as the confidence ratings 218 and 220. The confidence ratings 218 and 220 indicate to the controller 210 to detect which application being communicated over the encrypted tunnel. In one implementation, the higher the number of data packets, the higher the confidence rating 218 and 220. In this implementation, the number of data packets is directly proportional to the confidence ratings 218 and 220. In other implementations the confidence ratings 218 and 220 may be statistically determined based on the number of data packets. The higher the confidence ratings 218 and 220 the more likely the application corresponding to the packet size is being communicated via the encrypted tunnel. For example, Size A has two data packets and Size B has one data packet. Thus, the confidence rating 218 for Classifier 1 is a higher value than the confidence rating 220 for Classifier 2 208. The controller 210 uses the number of data packet sizes and/or the confidence ratings 218 and 220 to identify the application and tunneling protocol at modules 212-214. Each classifier 206 and 208, corresponding to the specific data packet size, represents a unique combination of a type of tunneling protocol and application. Thus, the classifier 206 or 208 may indicate to the controller the type of tunneling protocol. For example, one classifier may seek the specific packet size corresponding to Skype™ using secure shell (SSH), while another classifier may seek a different packet size which corresponds to data packets using Skype™ using a different tunneling protocol, such as a virtual private network (VPN).

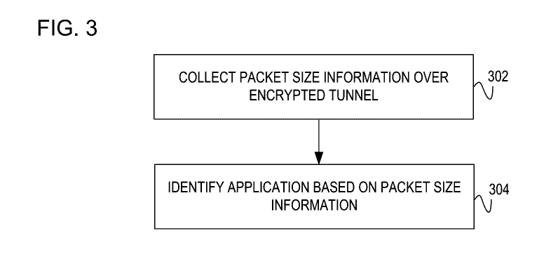

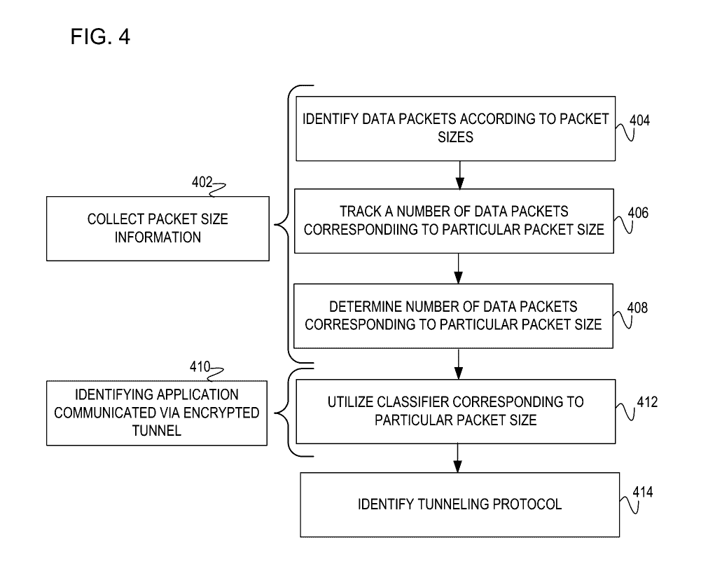

Referring now to FIGS. 3 and 4, flowcharts are illustrated in accordance with various examples of the present disclosure. The flowcharts represent processes that may be utilized in conjunction with various systems and devices as discussed with reference to the preceding figures. While illustrated in a particular order, the flowcharts are not intended to be so limited. Rather, it is expressly contemplated that various processes may occur in different orders and/or simultaneously with other processes than those illustrated.

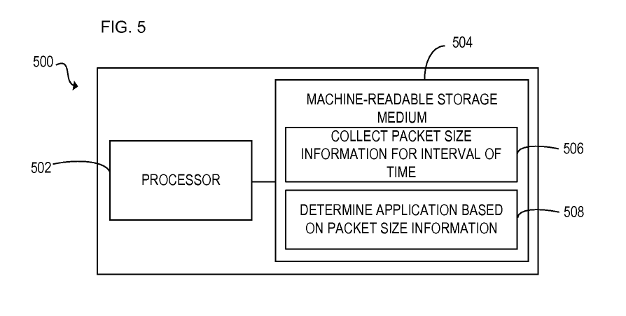

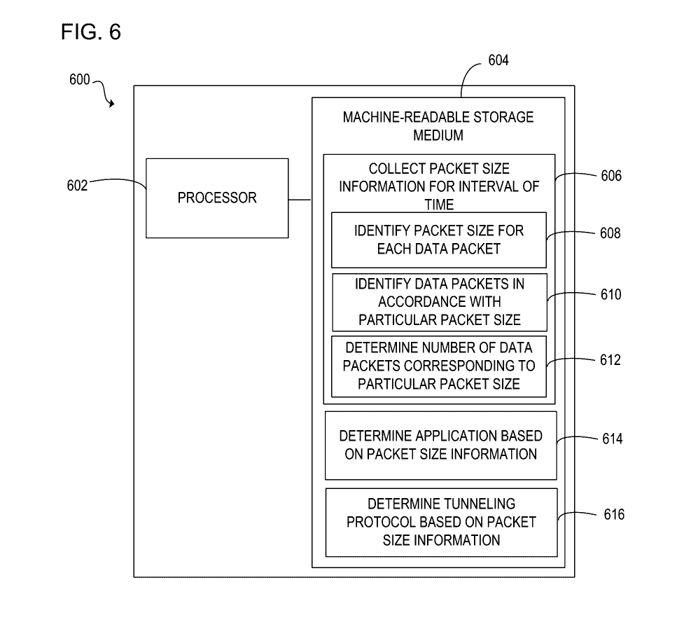

FIG. 3 illustrates a flowchart of an example method to identify an application based on packet size information collected over an encrypted tunnel. The method is executable by a networking device to identify the application. The networking device collects packet size information over an encrypted tunnel from data packets of various sizes. Using the packet size information, the networking device identifies the application which is communicated via the encrypted tunnel. In discussing FIG. 3, references may be made to the components in FIGS. 1-2 to provide contextual examples. In one implementation, the networking device 100 executes operations 302-304 to identify the application based on the packet size information. Although FIG. 3 is described as implemented by the networking device 100, it may be executed on other suitable components. For example, FIG. 3 may be implemented in the form of executable instructions on a machine-readable storage medium 504 and 604 as in FIGS. 5-6.

At operation 302, the networking device collects the packet size information over the encrypted tunnel. The networking device receives data packets and forwards the data packets between computer networks. In the background of the arrival of the data packets, the networking device uses the header information on the data packets to retrieve the packet size information. The packet size information indicates the overall packet length for each data packet. Particular packet lengths indicate to the networking device the application being communicated over the encrypted tunnel. For example, a packet length at 5 kB may indicate a telecommunication application, such as Skype™ while a packet length of 10 kB may indicate a social media application, such as Twitter™. In one implementation, the networking device tracks a number of the data packets which correspond to the specific or particular packet length. In this implementation, the networking device looks for the specific packet length and counts the number of data packets corresponding to that specific packet length. The higher the number of data packets, the more likely the corresponding application is being communicated via the encrypted tunnel. In another implementation, the networking device collects the packet size information from the data packets for an interval time. The interval of time indicates the time period in which to collect the data packets which may indicate a type of application. For example, one application may be communicated over the encrypted tunnel for ten seconds, while other applications may be communicated over the encrypted tunnel for two seconds. Thus, the interval of time indicates an optimal period of time in which to collect the packet size information to identify the application being communicated via the encrypted tunnel.

At operation 304, the networking device identifies the application which is communicated via the encrypted tunnel. The networking device uses the packet size information collected at operation 302 to identify the application. In one implementation, the networking device utilizes classifiers in which each classifier corresponds to a different packet size and a different application. Using these classifiers the networking device can collect the various packet sizes and determine which packet size is more common with a higher occurrence rate in the data traffic. The more common packet size indicates the application which is being communicated over the encrypted tunnel. Identifying the application using the particular packet length enables the networking device to determine the application without decrypting the data packets. Rather, the networking device utilizes the data packet size to determine if the application is being communicated over the encrypted tunnel.

FIG. 4 illustrates a flowchart of an example method to identify an application and tunneling protocol based on packet size information. The method is executable by a networking to device to identify the application and tunneling protocol. The networking device collects packet size information from data packets over an encrypted tunnel. The networking device may collect the packet size information by identifying the data packets in accordance with the various packet sizes and tracking a number of the data packets corresponding to the particular packet size (e.g., specific packet length). In this implementation, the networking device determines the number of data packets corresponding to the specific packet length. Collecting the packet size information, the networking device may identify the application and tunneling protocol which is used to communicate over the encrypted tunnel. In discussing FIG. 4, references may be made to the components in FIGS. 1-2 to provide contextual examples. In one implementation, the networking device 100 executes operations 402-414 to identify the application based on the packet size information. Although FIG. 4 is described as implemented by the networking device 100, it may be executable on other suitable components. For example, FIG. 4 may be implemented in the form of executable instructions on a machine-readable storage medium 504 and 604 as in FIGS. 5-6.

At operation 402, the networking device collects the packet size information from the data packets over the encrypted tunnel. In one implementation, the networking device proceeds to operations 404-408 to identify a number of data packets corresponding to a particular packet size. Upon identifying the number of data packets, the networking device identifies the application communicated via the encrypted tunnel. Operation 402 may be similar in functionality to operation 302 as in FIG. 3.

At operation 404, the networking device identifies the incoming data packets in accordance with the specific packet sizes for each data packet. The networking device uses the header information as part of the data packet to identify the various packet size lengths. Identifying the various packet lengths, the networking device can track the number of data packets per specific packet size as at operation 406.

At operation 406, the networking device tracks the number of data packets which correspond to the particular packet size. The networking device may track the various packet sizes of the data packets. The networking device may collect those data packets corresponding to the specific or particular packet size. Collecting the data packets enables the networking device to determine the number of data packets corresponding to the specific packet size as at operation 408.

At operation 408, the networking device determines the number of data packets corresponding to the particular packet size. The number of packets corresponding to the specific packet size are determined over an interval of time. The number of data packets indicates whether the application is being communicated in the data packets via the encrypted tunnel. In one implementation, the higher the number of data packets indicates the more frequently that data packets corresponding to the specific packet size is communicated via the encrypted tunnel.

At operation 410, the networking device identifies the application communicated via the encrypted tunnel. The networking device uses the packet size information collected at operations 402-408 to identify which application is being communicated via the encrypted tunnel. In one implementation, the networking device utilizes a classifier to identify the application at operation 412. Operation 410 may be similar in functionality to operation 304 as in FIG. 3.

At operation 412, the networking device utilizes the classifier to identify the application and the tunneling protocol. The classifier provides a statistical classification for the specific packet size. In this implementation, the classifier represents a unique combination of the specific tunneling protocol and the specific packet size. Thus the classifier analyses the data packets to estimate the number of data packets corresponding to the specific packet size it may be classifying. The classifier may be implemented in a variety of ways including a likelihood function or decision tree. In the likelihood implementation, the classifier provides an estimate of how likely the application is being communicated via the encrypted tunnel. The estimate is based on the number of data packets which correspond to the specific packet size the classifier may be seeking. Thus, the higher the number of data packets corresponding to the specific packet size, the more likely the application is being communicated via the encrypted tunnel. In the decision tree implementation, the classifier operates as a model of decisions (branches) with potential outcomes (leaves) of each decision. For example, the first decision may include analyzing each data packet to identify whether the data packet is within the specific packet size. The next decision may include if the number of data packets at the specific packet size has reached a specific value.

At operation 414, the networking device identifies the tunneling protocol communicated via the encrypted tunnel. The tunneling protocol is identified based on the packet sizes of the data packets received by the networking device. In this implementation, the tunneling protocol may be based on the number of data packets corresponding to the specific packet size. Each classifier represents a unique combination of the tunneling protocol and the specific application. Using the unique combination, each classifier can identify a different application and tunneling protocol combination. For example, one classifier may seek the specific packet size corresponding to Skype™ with a tunneling protocol using secure shell (SSH), while another classifier may seek a different packet size which corresponds to data packets using Skype™ using a different tunneling protocol, such as a virtual private network (VPN).

FIG. 5 is a block diagram of computing device 500 with a processing resource 502 to execute instructions 506-508 within a machine-readable storage medium 504. Specifically, the computing device 500 with the processing resource 502 is to collect packet size information over an interval of time. The packet size information is collected from data packets over an encrypted tunnel. Based on the packet size information, the processing resource 502 determines an application which is communicated via the encrypted tunnel. Although the computing device 500 includes processing resource 502 and machine-readable storage medium 504, it may also include other components that would be suitable to one skilled in the art. For example, the computing device 500 may include the controller 110 as in FIG. 1. The computing device 500 is an electronic device with the processing resource 502 capable of executing instructions 506-508, and as such embodiments of the computing device 500 include a router, networking device, switch, mobile device, client device, personal computer, desktop computer, laptop, tablet, or other type of electronic device capable of executing instructions 506-508. The instructions 506-508 may be implemented as methods, functions, operations, and other processes implemented as machine-readable instructions stored on the storage medium 504, which may be non-transitory, such as hardware storage devices (e.g., random access memory (RAM), read only memory (ROM), erasable programmable ROM, electrically erasable ROM, hard drives, and flash memory).

The processing resource 502 may fetch, decode, and execute instructions 506-508 to determine the application associated with the data packets based on the packet size information. Specifically, the processing resource 502 executes instructions 506-508 to: collect the packet size information from incoming data packets over the interval of time, the data packets are transmitted over the encrypted tunnel; and based on the packet size information, determine the application which is communicated via the encrypted tunnel in connection with the data packets.

The machine-readable storage medium 504 includes instructions 506-508 for the processing resource 502 to fetch, decode, and execute. In another embodiment, the machine-readable storage medium 504 may be an electronic, magnetic, optical, memory, storage, flash-drive, or other physical device that contains or stores executable instructions. Thus, the machine-readable storage medium 504 may include, for example, Random Access Memory (RAM), an Electrically Erasable Programmable Read-Only Memory (EEPROM), a storage drive, a memory cache, network storage, a Compact Disc Read Only Memory (CDROM) and the like. As such, the machine-readable storage medium 504 may include an application and/or firmware which can be utilized independently and/or in conjunction with the processing resource 502 to fetch, decode, and/or execute instructions of the machine-readable storage medium 504. The application and/or firmware may be stored on the machine-readable storage medium 504 and/or stored on another location of the computing device 500.

FIG. 6 is a block diagram of computing device 600 with a processing resource 602 to execute instructions 606-616 within a machine-readable storage medium 604. Specifically, the computing device 600 with the processing resource 602 is to determine an application and a tunneling protocol communicated via an encrypted tunnel based on packet size information. The packet size information is obtained from incoming data packets to the networking device. Although the computing device 600 includes processing resource 602 and machine-readable storage medium 604, it may also include other components that would be suitable to one skilled in the art. For example, the computing device 600 may include the controller 110 as in FIG. 1. The computing device 600 is an electronic device with the processing resource 602 capable of executing instructions 606-616, and as such embodiments of the computing device 600 include a router, networking device, switch, mobile device, client device, personal computer, desktop computer, laptop, tablet, or other type of electronic device capable of executing instructions 606-616. The instructions 606-616 may be implemented as methods, functions, operations, and other processes implemented as machine-readable instructions stored on the storage medium 604, which may be non-transitory, such as hardware storage devices (e.g., random access memory (RAM), read only memory (ROM), erasable programmable ROM, electrically erasable ROM, hard drives, and flash memory).

The processing resource 602 may fetch, decode, and execute instructions 606-616 to determine the application and the tunneling protocol communicated via the encrypted tunnel. Specifically, the processing resource 602 executes instructions 606-616 to: collect the packet size information from incoming data packets transmitted over the encrypted tunnel for the interval of time; identify a packet size for each of the incoming data packets; identify the data packets in accordance with a particular packet size; determine a number of data packets corresponding to the particular packet size; determine the application based on the number of data packets corresponding to the particular packet size which are transmitted via the encrypted tunnel; and determine the tunneling protocol corresponding to the particular packet size.

The machine-readable storage medium 604 includes instructions 606-616 for the processing resource 602 to fetch, decode, and execute. In another embodiment, the machine-readable storage medium 604 may be an electronic, magnetic, optical, memory, storage, flash-drive, or other physical device that contains or stores executable instructions. Thus, the machine-readable storage medium 604 may include, for example, Random Access Memory (RAM), an Electrically Erasable Programmable Read-Only Memory (EEPROM), a storage drive, a memory cache, network storage, a Compact Disc Read Only Memory (CDROM) and the like. As such, the machine-readable storage medium 504 may include an application and/or firmware which can be utilized independently and/or in conjunction with the processing resource 602 to fetch, decode, and/or execute instructions of the machine-readable storage medium 604. The application and/or firmware may be stored on the machine-readable storage medium 604 and/or stored on another location of the computing device 600.

Although certain embodiments have been illustrated and described herein, it will be greatly appreciated by those of ordinary skill in the art that a wide variety of alternate and/or equivalent embodiments or implementations calculated to achieve the same purposes may be substituted for the embodiments shown and described without departing from the scope of this disclosure. Those with skill in the art will readily appreciate that embodiments may be implemented in a variety of ways. This application is intended to cover adaptions or variations of the embodiments discussed herein. Therefore, it is manifestly intended that embodiments be limited only by the claims and equivalents thereof.

We claim:

1. A method, executable by a networking device, the method comprising:
collecting packet size information over an encrypted tunnel; and
identifying an application communicated via the encrypted tunnel based on the packet size information.

2. The method of claim 1 wherein collecting packet size information communicated via the encrypted tunnel comprises:
determining a number of data packets corresponding to a particular packet size over an interval of time.

3. The method of claim 1 wherein collecting the packet size information communicated via the encrypted tunnel comprises:
identifying data packets in accordance with a particular packet size; and
tracking a number of the data packets corresponding to the particular size.

4. The method of claim 1 wherein the networking device collects the packet size information without decrypting a data packet.

5. The method of claim 1 comprising:
identifying a tunneling protocol communicated via the encrypted tunnel based on the packet size information.

6. The method of claim 1 wherein identifying the application communicated via the encrypted tunnel based on the packet size information comprises:
utilizing a classifier corresponding to a particular packet size, the classifier representative of a tunneling protocol in combination with the application.

7. A networking device comprising:
a classifier, corresponding to an application, that classifies data packets over an encrypted tunnel according to a particular packet size; and
a controller that identifies the application communicated via the encrypted tunnel based on the particular packet size.

8. The networking device of claim 7 comprising:
a different classifier, corresponding to a different application, that classifies the data packets over the encrypted tunnel according to a different packet size.

9. The networking device of claim 7 wherein:
the classifier corresponds to a tunneling protocol; and
the controller that identifies the tunneling protocol communicated via the encrypted tunnel based on the particular packet size.

10. The networking device of claim 7 wherein the classifier that classifies the data packets over the encrypted tunnel according to the particular packet size comprises:
determines a number of the data packets corresponding to the particular packet size.

11. A non-transitory machine-readable storage medium comprising instructions that when executed by a processing resource cause a networking device to:
collect packet size information over an encrypted tunnel for an interval of time; and
determine an application communicated via the encrypted tunnel based on the packet size information.

12. The non-transitory machine-readable storage medium of claim 11 comprising instructions that when executed by the processing resource cause the networking device to:
determine a tunneling protocol communicated via the encrypted tunnel based on the packet size information, wherein the tunneling protocol and the application are dependent on a particular packet size.

13. The non-transitory machine-readable storage medium of claim 11 wherein to collect the packet size information over the encrypted tunnel for the interval of time comprises instructions that when executed by the processing resource cause the networking device to:
determine a number of data packets corresponding to a particular packet size, the number of data packets indicates whether the application is being communicated via the encrypted tunnel.

14. The non-transitory machine-readable storage medium of claim 11 wherein to collect packet size information over the encrypted tunnel for the interval of time comprises instructions that when executed by the processing resource cause the networking device to:
identify a packet size for each data packet transmitted over the encrypted tunnel.

15. The non-transitory machine-readable storage medium of claim 11 wherein the application corresponds to a particular packet size.
